(19) United States
(12) Patent Application Publication
(10) Pub. No.: US 2012/0089922 A1
(43) Pub. Date: Apr. 12, 2012

(54) Apparatus and method for effectively implementing system and desktop configuration enhancements

(75) Inventors: Sean Kennedy, San Diego, CA (US); Fredrik Carpio, Menifee, CA (US); Rommel Garay, San Marco, CA (US); Paul Hwang, San Diego, CA (US); Gary Lyons, San Diego, CA (US); Christopher Ohren, San Diego, CA (US); Edward Winter, San Diego, CA (US)

(73) Assignee: Sony Corporation

(21) Appl. No.: 12/924,903

(22) Filed: Oct. 7, 2010

(51) Int. Cl. G06F 3/01

(52) U.S. Cl. 715/744

(57) ABSTRACT

An apparatus for effectively implementing system and desktop configuration enhancements in an electronic device includes a user interface that a device user may utilize to interact with the electronic device. In accordance with the present invention, various appropriate means for enhancing the utilization capabilities of the user interface are implemented and supported. The electronic device further includes a processor device that is configured to control the means for enhancing the utilization capabilities of the user interface.

### BACKGROUND SECTION

1. Field of the Invention

This invention relates generally to techniques for utilizing electronic devices, and relates more particularly to an apparatus and method for effectively implementing system and desktop configuration enhancements.

2. Description of the Background Art

Implementing effective methods for utilizing electronic devices is a significant consideration for designers and manufacturers of contemporary electronic devices. However, effectively implementing and utilizing electronic devices may create substantial challenges for devices designers. For example, enhanced demands for increased device functionality and performance may require more device processing power and require additional hardware resources. An increase in processing or hardware requirements may also result in a corresponding detrimental economic impact due to increased production costs and operational inefficiencies.

Furthermore, enhanced device capability to perform various advanced operations may provide additional benefits to a device user, but may also place increased demands on the control and management of various device components. For example, an enhanced electronic device that effectively supports streaming video may benefit from an efficient implementation because of the large amount and complexity of the digital data involved.

Due to growing demands on device resources and substantially increasing data magnitudes, it is apparent that developing new techniques for implementing and utilizing electronic devices is a matter of concern for related electronic technologies. Therefore, for all the foregoing reasons, developing effective techniques for implementing and utilizing electronic devices remains a significant consideration for designers, manufacturers, and users of contemporary electronic devices.

### SUMMARY

In accordance with the present invention, an apparatus and method are disclosed for effectively implementing system and desktop configuration enhancements. A first inventive aspect of the present invention supports pre-configuring a user interface (desktop) on a computer device based upon either advanced or standard personalities of a corresponding device user. The present invention supports a set of profiles that may be implemented by utilizing user feedback. For example, an out-of-the-box (OOBE) program may provide a brief user survey during a corresponding OOBE procedure.

A second inventive aspect of the present invention supports utilizing information gathered during the OOBE procedure to configure the computer device. For example, the OOBE program may analyze OOBE information to set up hot-keys, most-frequently-used items, Internet bookmarks, desktop icons, and Internet browser(s). In addition, information gathered during the OOBE procedure may be utilized to set up one or more social networking software portals, or to setup fingerprint or facial recognition features for system security on the computer device.

A third inventive aspect of the present invention features a query module that may utilize a device user's e-mail address to query appropriate entities to determine online services with which the device user is a participant or member. Furthermore, from the foregoing OOBE procedure and device user's e-mail information, frequently-visited Internet sites may be determined. From this information, the computer device may automatically perform numerous configuration functions.

A fourth inventive aspect of the present invention automatically performs a specific analysis procedure according to predefined criteria to determine whether devices user are advanced or standard users. Examples of the evaluation criteria may include whether a device user utilizes short-cut keys in the OOBE procedure, how long the OOBE procedure takes to complete, whether the device user is able to successfully setup Wifi/WWAN connections, whether the user's mouse movements are determined or random, and how quickly the device user is able to type. In certain embodiments, the evaluation criteria may also include analysis of user facial expressions captured by a camera during the OOBE, regional information from user registration, and utilization of a Myers-Briggs Type Indicator (MBTI).

A fifth inventive aspect of the present invention supports an expanded search manager that provides a drag-and-drop search bar and local metadata on the desktop of computer. A device user may drag and drop desired search item (a photo, text, file, graphics, etc.) into the search bar. The search manager may then automatically query any appropriate entity against all the metadata attached to that search item.

A sixth inventive aspect of the present invention utilizes an icon manager to support dynamic icons on the computer device. The icon manager creates dynamic icons on the desktop to act as “drawers” for critical software. This allows device users to have quick access to preinstalled software and/or user-selected directories or files, and to be able to open or launch the software easily without cluttering up the desktop with shortcuts to the most commonly used items.

In certain embodiments, the icon manager may support dynamic icons for any desired dynamic icon categories. For example, the dynamic icon categories may include a productivity software category, a computer-specific software category, and an entertainment software category. In certain embodiments, when a device user positions the mouse cursor over a given dynamic icon, then the icon manager may automatically expand the particular dynamic icon to show useful software programs that are nested within the dynamic icon.

For all the foregoing reasons, the present invention therefore provides an improved apparatus and method for effectively implementing system and desktop configuration enhancements on an electronic device.

### BRIEF DESCRIPTION OF THE DRAWINGS

FIG. 1 is a block diagram of an electronic network, in accordance with one embodiment of the present invention;

FIG. 2 is a block diagram for one embodiment of the computer of FIG. 1, in accordance with the present invention;

FIG. 3 is a block diagram for one embodiment of the memory of FIG. 2, in accordance with the present invention;

FIG. 4 is a block diagram for one embodiment of the OOBE program of FIG. 3, in accordance with the present invention;

FIG. 5 is a diagram illustrating an OOBE configuration procedure, in accordance with one embodiment of the present invention;

FIG. 6 is a diagram illustrating a configuration file creation procedure, in accordance with one embodiment of the present invention;

FIG. 7 is a diagram illustrating a dynamic icon creation procedure, in accordance with one embodiment of the present invention; and

FIGS. 8A-8E are diagrams illustrating dynamic icon utilization procedures, in accordance with respective embodiments of the present invention.

### DETAILED DESCRIPTION

The present invention relates to improvements in utilizing electronic devices. The following description is presented to enable one of ordinary skill in the art to make and use the invention, and is provided in the context of a patent application and its requirements. Various modifications to the disclosed embodiments will be readily apparent to those skilled in the art, and the generic principles herein may be applied to other embodiments. Thus, the present invention is not intended to be limited to the embodiments shown, but is to be accorded the widest scope consistent with the principles and features described herein.

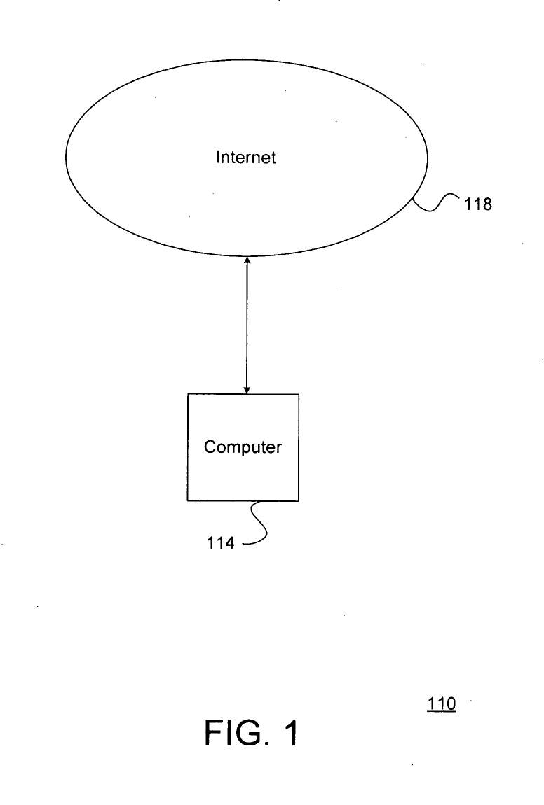

Referring now to FIG. 1, a block diagram of an electronic network 110 is shown, in accordance with one embodiment of the present invention. In the FIG. 1 embodiment, electronic network 110 may include, but is not limited to, at least one computer 114 and the Internet 118. In alternate embodiments, electronic network 110 may be implemented using various components and configurations in addition to, or instead of, certain of those components and configurations discussed in conjunction with the FIG. 1 embodiment. For example, the Internet 118 may be implemented as any effective electronic network that includes any appropriate types of electronic devices.

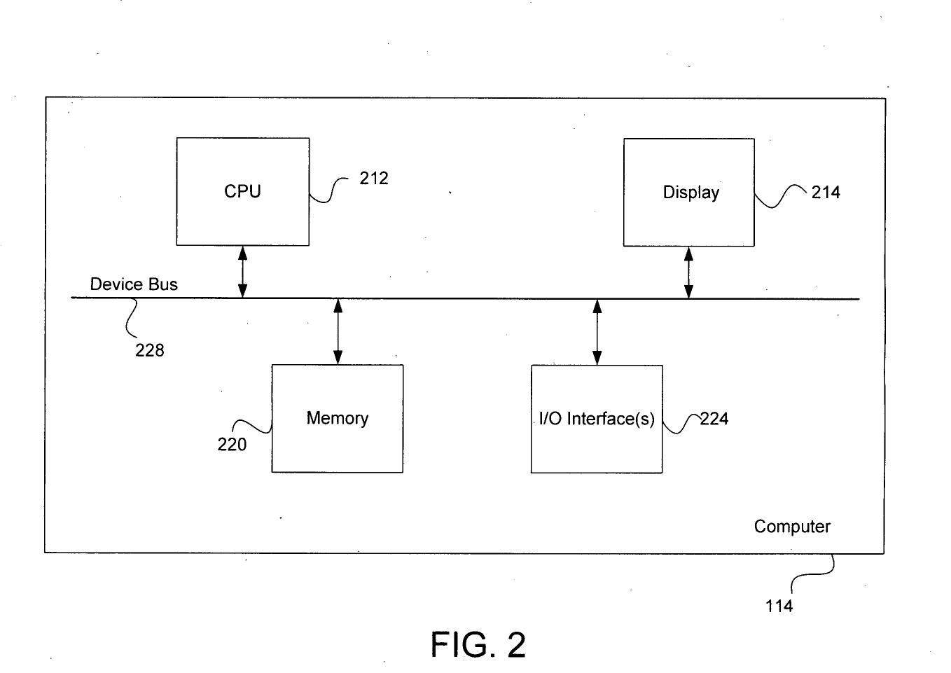

In the FIG. 1 embodiment, computer 114 may be implemented as any electronic device that is configured to support and manage various functionalities for a device user. In the FIG. 1 embodiment, computer 114 may participate in bi-directional communications with entities on the Internet 118 by utilizing any effective communication techniques. The implementation and utilization of the FIG. 1 computer 114 is further discussed below in conjunction with FIGS. 2-8.

Referring now to FIG. 2, a block diagram for one embodiment of the FIG. 1 computer 114 is shown, in accordance with the present invention. In the FIG. 2 embodiment, computer 114 may include, but is not limited to, a central processing unit (CPU) 212, a display 214, a memory 220, and input/output interfaces (I/O interfaces) 224. Certain of the foregoing components of computer 114 may be coupled to, and communicate through, a device bus 228. In alternate embodiments, computer 114 may be implemented using components and configurations in addition to, or instead of, those certain of those components and configurations discussed in conjunction with the FIG. 2 embodiment. Furthermore, computer 114 may alternately be implemented as any other desired type of electronic device or entity.

In the FIG. 2 embodiment, CPU 212 may be implemented to include any appropriate and compatible microprocessor device that preferably executes software instructions to thereby control and manage the operation of computer 114. In the FIG. 2 embodiment, display 214 may include any effective type of display technology including a cathode-ray-tube monitor or a liquid-crystal display device with an appropriate screen for displaying various information to a device user. In accordance with the present invention, display 214 may provide a user interface referred to as a “desktop” that includes icons, menus, and any other appropriate means for accessing and utilizing corresponding functionalities of computer 114.

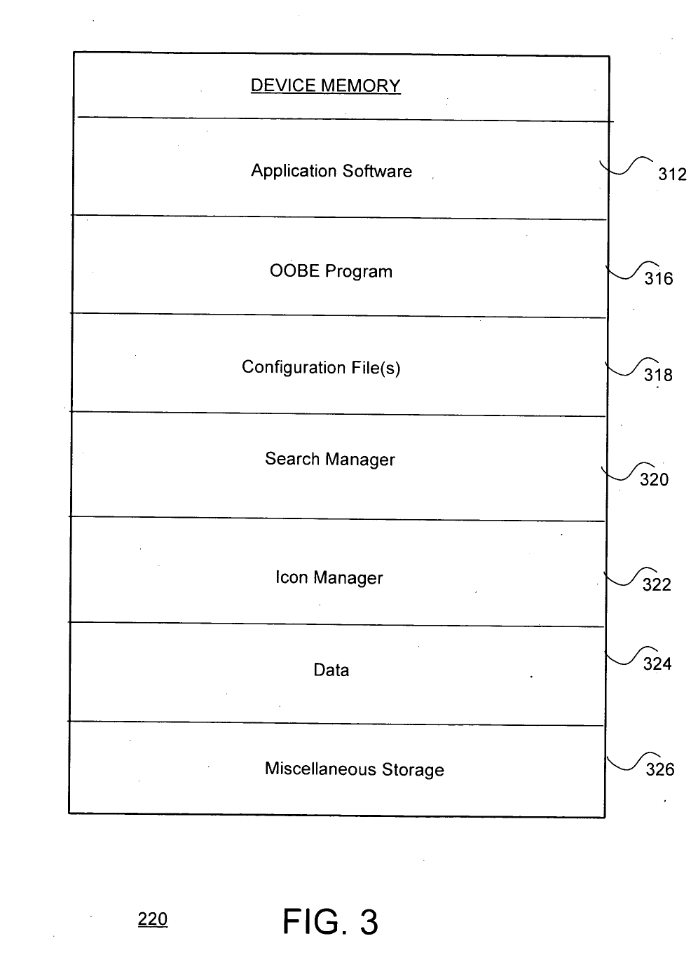

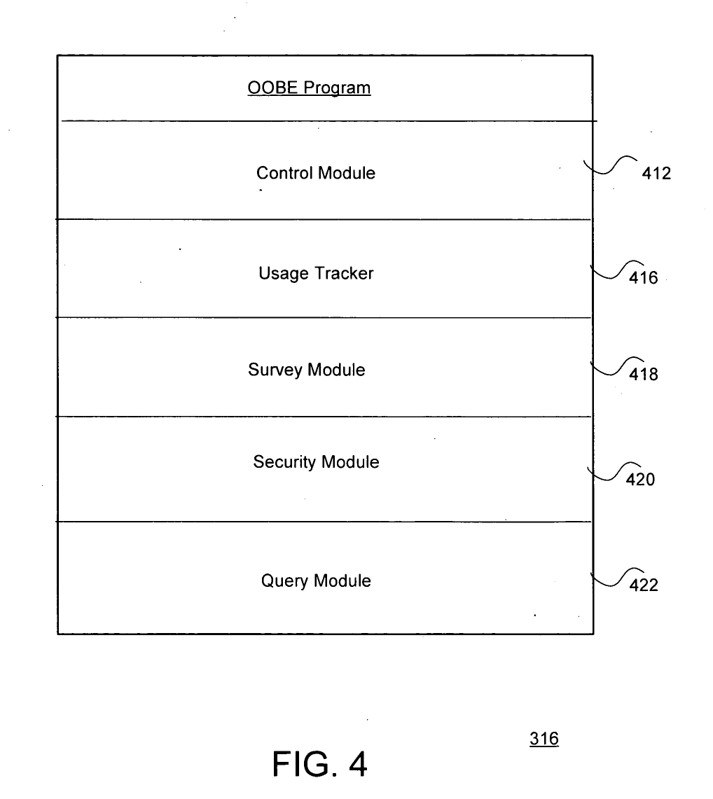

In the FIG. 2 embodiment, memory 220 may be implemented to include any combination of desired storage devices, including, but not limited to, read-only memory (ROM), random-access memory (RAM), and various types of non-volatile memory, such as floppy disks or hard disks. The contents and functionality of memory 220 are further discussed below in conjunction with FIGS. 3 and 4. In the FIG. 2 embodiment, I/O interfaces 224 may include one or more input and/or output interfaces to receive and/or transmit any required types of information for computer 114. For example, a device user may utilize I/O interfaces 224 to communicate with computer 114 by utilizing any appropriate and effective techniques. Additional details regarding the implementation and utilization of the FIG. 2 computer 114 are further discussed below in conjunction with FIGS. 3-8.

Referring now to FIG. 3, a block diagram for one embodiment of the FIG. 2 memory 220 is shown, in accordance with the present invention. In the FIG. 3 embodiment, memory 220 includes, but is not limited to, application software 312, an out-of-the-box experience (OOBE) program 316, one or more configuration files 318, a search manager 320, an icon manager 322, data 324, and miscellaneous storage 326. In alternate embodiments, memory 220 may include various components and functionalities in addition to, or instead of, certain of those components and functionalities discussed in conjunction with the FIG. 3 embodiment.

In the FIG. 3 embodiment, application software 312 may include program instructions that are preferably executed by CPU 212 (FIG. 2) to perform various functions and operations for computer 114. The particular nature and functionality of application software 312 preferably varies depending upon factors such as the specific type and particular functionality of the corresponding computer 114. In the FIG. 3 embodiment, an operating system (not shown) preferably controls and coordinates low-level functionality of computer 114.

In the FIG. 3 embodiment, OOBE program 316 includes a configuration program that controls and coordinates an initial computer setup and configuration procedure for computer 114 by performing any appropriate functions or tasks, in accordance with the present invention. In the FIG. 3 embodiment, configuration file(s) 318 may include any type of information that defines or specifies characteristics of computer 114. For example, a configuration file 318 may include information regarding a user interface or desktop configuration for most-effectively utilizing computer 114.

In the FIG. 3 embodiment, search manager 320 may be utilized to perform appropriate searches on computer 114 and/or the Internet 118 (see FIG. 1) to identify or access any desired information. For example, in certain embodiments, search manager 320 may be utilized to conduct various drag-and-drop searches, as further discussed below. In the FIG. 3 embodiment, icon manager 322 may be utilized to support dynamic icons on computer 114, as further discussed below.

In the FIG. 3 embodiment, data 324 may include any appropriate information or data for use by computer 114. For example, data 324 may include various types of information required by computer 114 to optimally populate and utilize one or more configuration files 318. In the FIG. 3 embodiment, miscellaneous storage 326 may include any other information required by computer 114.

In the FIG. 3 embodiment, the present invention may utilize a number of different inventive aspects to provide beneficial enhancements for system and desktop configurations of computer 114. With regard to computer 114, there may potentially be many different varied types of users, from the very adept to the very inept. The present invention therefore provides improved functionality to configure computer 114 based on predefined factors such as the device users' personality, usage characteristics of computer 114, and the technical capability of the device users. The present invention therefore provides easily-used tools which allow device users to quickly find and access appropriate files and functionalities on computer 114.

A first inventive aspect of the present invention supports pre-configuring a user interface (desktop) on computer 114 based upon either advanced or standard personalities of a corresponding device user. The present invention supports a set of profiles that may be implemented by utilizing user feedback. For example, OOBE program 316 may provide a brief user survey during an OOBE procedure. Sample questions may include whether the user likes a clean desktop, whether the user likes quick access to recent documents, whether the user prefers start MFUs (most-frequently used functions), and whether the user likes a task tray to be displayed for important tasks.

These options may be determined by how the device user responds to the OOBE survey. For example, if a device user easily completes the OOBE procedure, then it may be assumed that the device user is likely to be an advance user and would prefer a cleaner desktop with fewer icons and menus displayed. As another example, if a device user enters a beginner's e-mail address (such as AOL), then it can be assumed that they are not as technically savvy as someone who enters a more advanced email address.

A second inventive aspect of the present invention supports utilizing information gathered during the OOBE procedure to configure computer 114. For example, OOBE program 316 may analyze OOBE information to set up hot-keys, MFUs, a superbar of various tools, Internet bookmarks, desktop icons, Internet browser(s), and search ads, etc. In addition, information gathered during the OOBE procedure may be utilized to set up one or more social networking software portals, or to setup fingerprint or facial recognition features for system security on computer 114.

A third inventive aspect of the present invention features a query module (see FIG. 4) that may utilize a device user's e-mail address to query computer 114, the Internet 118 (FIG. 1), or other appropriate entities to determine online services with which the device user is a participant or member. Furthermore, from the foregoing OOBE procedure and device user's e-mail information, frequently visited Internet sites may be determined. From this information, computer 114 may automatically perform numerous configuration functions. For example, computer 114 may automatically set up appropriate bookmarks and populate MFUs. The gathered information may also be utilized to determine whether the device user is a social networker, and in which specific social networks the device user is a participant.

In addition, computer 114 may utilize the foregoing information to estimate whether the device user is advanced or standard according to predefined criteria. Examples of the predefined criteria may include whether the device user utilizes AOL (standard) or Gmail (advanced), or whether the device user has multiple separate email addresses (advanced). For a standard user, computer 114 may perform appropriate functions like creating desktop links to frequently-used Internet sites, creating superbar links to important applications, and enabling gadgets for popular sites/applications. In contrast, for an advanced user, computer 114 may perform appropriate functions like creating a clean desktop with relatively few icons or menus displayed.

A fourth inventive aspect of the present invention automatically performs a specific analysis procedure to identify whether devices users are advanced or standard users. In certain embodiments, a greater number of different levels of expertise may be recognized and supported, ranging from very experienced to very inexperienced. The determination of either advanced or standard may be made according to any appropriate criteria that may be either weighted/prioritized or not.

Examples of the evaluation criteria may include whether a device user utilizes short-cut keys in the OOBE procedure (advanced), how long the OOBE procedure takes to complete, whether the device user is able to successfully setup Wifi/WWAN connections, whether the user's mouse movements are determined (advanced) or random (standard), and how quickly the device user is able to type. In certain embodiments, the evaluation criteria may also include analysis of user facial expressions captured by a camera during the OOBE, regional information from user registration (e.g., zip code of rural area=lower technical expertise), and utilization of a Myers-Briggs Type Indicator (MBTI).

A fifth inventive aspect of the present invention supports an expanded search manager 320 that provides a drag-and-drop search bar and local metadata on the desktop of computer 114. A device user may then drag and drop a desired search item (a photo, text, file, graphics, etc.) into the search bar. Search manager 320 may then automatically query computer 114, the Internet 118, and/or any other appropriate entity against all the metadata attached to that search item.

In the FIG. 3 embodiment, search manager 320 may be implemented to search for any desired information. For example, search manager 320 may locate similar content, frequent words (e.g., plagiarized words), titles, chapters, and key terms. In certain embodiments, search manager 320 may also locate data on family members or other persons via metadata (names, pictures, etc). Furthermore, search manager 320 may search device user data on the Internet and digital media from any appropriate source.

A sixth inventive aspect of the present invention utilizes icon manager 322 to support dynamic icons on computer 114. It is sometimes difficult for a device user to find useful software, directories or files on computer 114. Accordingly, icon manager 322 creates dynamic icons on the desktop to act as “drawers” for critical software. This allows device users to have quick access to preinstalled software and/or user-selected directories or files, and to be able to open or launch the software easily without cluttering up the desktop with shortcuts to the most commonly used items.

In certain embodiments, icon manager 322 may support dynamic icons for any desired dynamic icon categories. For example, the dynamic icon categories may include a productivity software category, a computer-specific software category, and an entertainment software category. In certain embodiments, when a device user positions the mouse cursor over a given dynamic icon, then icon manager 322 may automatically expand the particular dynamic icon to show useful software programs that are nested within the dynamic icon.

Examples of nested productivity software may include, but are not limited to, Outlook, Excel, Word, Gmail, Google Docs, and various types of collaboration software. Examples of nested productivity software for the Sony VAIO PC may include, but are not limited to, Media Gallery, Movie Story, PMB, VAIO Care, VAIO Control Center, and Sony Style. Examples of nested entertainment software may include, but are not limited to, preloaded movies, games, Sony movies, and Sony music.

In certain embodiments, dynamic icons may be transparent until moused-over or a special key is pressed. Furthermore, in certain embodiments, dynamic icons automatically move to uncover important background areas (e.g., someone's face). As mentioned above, dynamic icons may be nested within each other. In one embodiment, a first dynamic icon could provide shortcuts to access to common applications like Microsoft Word Shortcut and Adobe Premiere. Similarly, a second dynamic icon could provide shortcuts to art programs like Adobe Photoshop, Adobe Illustrator Shortcut, Adobe Image Ready, and Microsoft Paint Shortcut. In certain embodiments, nested dynamic icons may have fold-out animations that create layers of access. Additional details regarding implementation and utilization of device memory 220 are further discussed below in conjunction with FIGS. 4 through 8.

Referring now to FIG. 4, a block diagram of the FIG. 3 OOBE program 316 is shown, in accordance with one embodiment of the present invention. In the FIG. 4 embodiment, OOBE program 316 may include, but is not limited to, a control module 412, a usage tracker 416, a survey module 418, a security module 420, and a query module 422. In alternate embodiments, personal channel manager 324 may be implemented using various components and configurations in addition to, or instead of, those components and configurations discussed in conjunction with the FIG. 4 embodiment.

In the FIG. 4 embodiment, OOBE program 316 may utilize control module 412 to provide appropriate management functions for coordinating an OOBE configuration procedure for computer 114. In the FIG. 4 embodiment, OOBE program 316 may utilize usage tracker 416 to monitor and compile predefined information and statistics regarding the usage characteristics of computer 114. In the FIG. 4 embodiment, OOBE program 316 may utilize survey module 418 to coordinate a user survey procedure for compiling relevant information regarding a device user of computer 114.

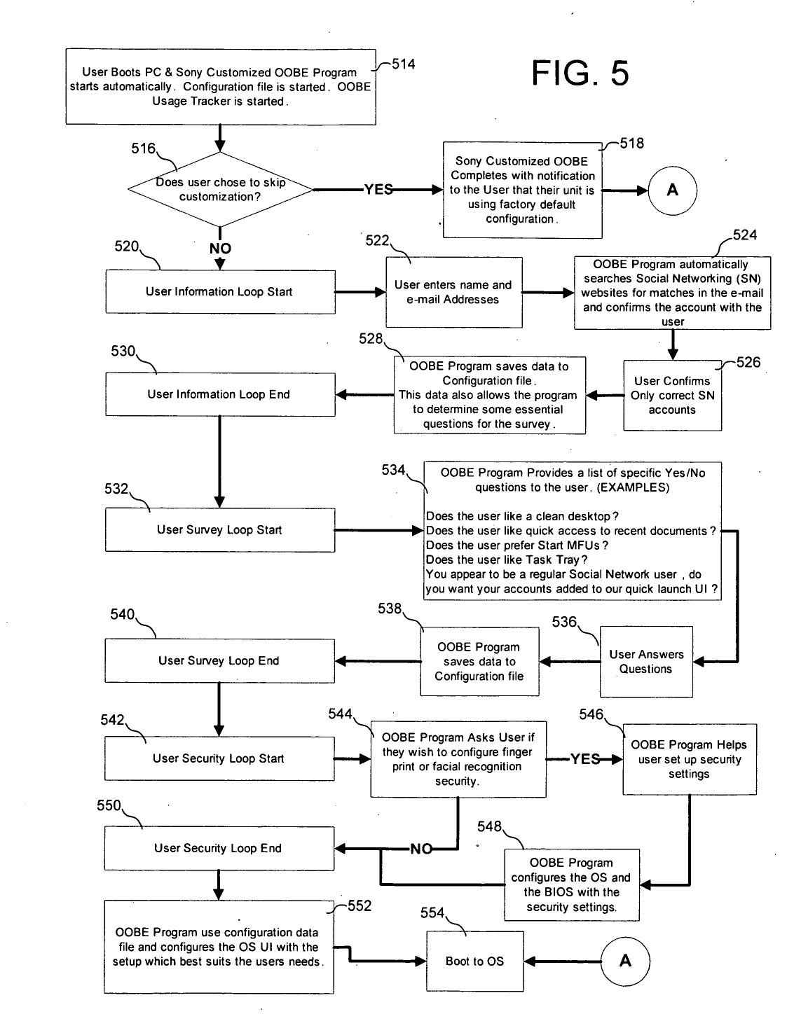

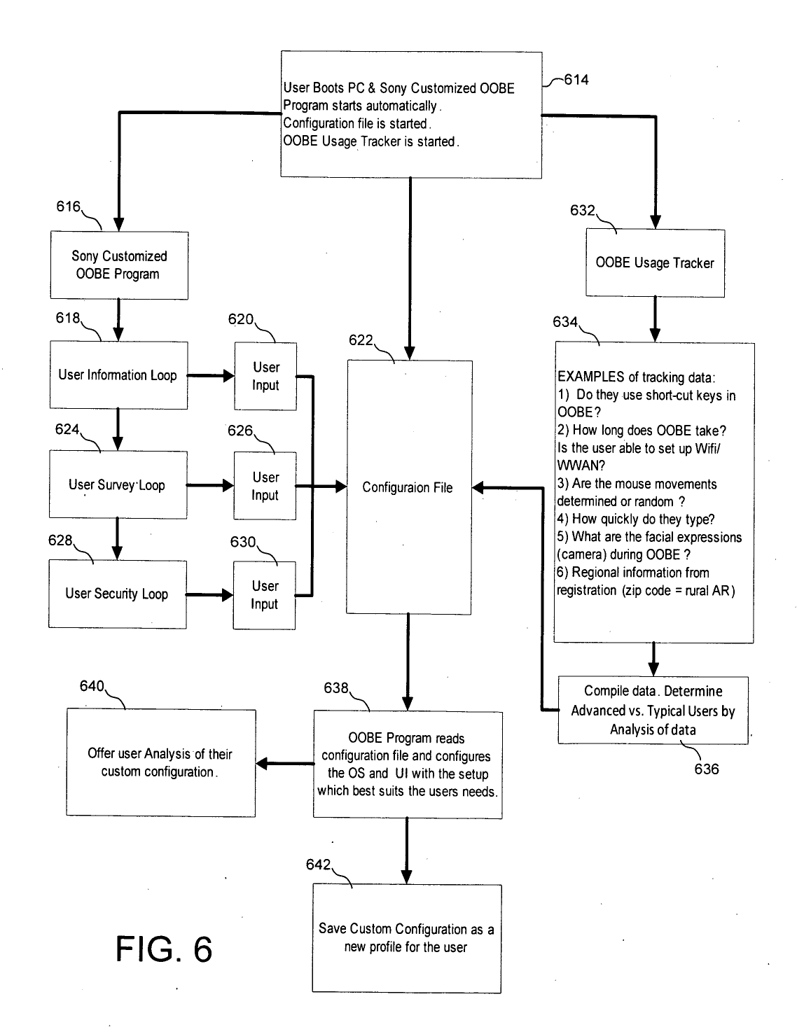

In the FIG. 4 embodiment, OOBE program 316 may utilize security module 412 to setup and configure appropriate security functionality for computer 114. In the FIG. 4 embodiment, OOBE program 316 may utilize query module 422 to conduct query procedures for gathering predefined information regarding a device user of computer 114. Additional details regarding implementation and utilization of the OOBE program 316 further discussed below in conjunction with FIGS. 5 and 6.

Referring now to FIG. 5, a diagram illustrating an OOBE configuration procedure is shown, in accordance with one embodiment of the present invention. The FIG. 5 example is presented for purposes of illustration, and in alternate embodiments, the present invention may utilize steps and sequences other than certain of those steps and sequences discussed in conjunction with the FIG. 5 embodiment.

In the FIG. 5 embodiment, in block 514, a device user initially boots computer 114 and the OOBE program 316 (FIG. 3) starts automatically. A configuration file 318 (FIG. 3) and usage tracker 416 (FIG. 4) are also started. In block 516, OOBE program 316 determines whether the device user has chosen to skip customization of computer 114. If the device user chooses to skip customization, then in block 518, the OOBE procedure notifies the device user that computer 114 will be configured with a factory default configuration. In step 554, computer 114 may then boot to the operating system.

However, if the device user chooses not to skip customization, then in block 520, OOBE program 316 starts a user information loop. In block 522, the device user enters their name and one or more email addresses. In block 524, a query module 422 (FIG. 4) of OOBE program 316 may automatically search social network websites for matches to the user email addresses. OOBE program 316 displays the located social network accounts to the device user. In block 526, the device user may then confirm only the correct social network accounts. In block 528, OOBE program 316 saves all collected information/data to the configuration file 318. OOBE program 316 may also utilize the collected data to determine essential questions for a user survey. In block 530, the user information loop may terminate.

In block 532, a survey module 418 (FIG. 4) of OOBE program 316 starts a user survey loop. In block 534, survey module 418 provides a list of specific survey questions to the device user. In certain embodiments, the questions may be implemented as yes/no questions, as illustrated in the FIG. 5 examples of block 534. In block 536, the device user provides answers to the displayed survey questions. In block 538, survey module 418 saves correspond survey data (such as the survey question answers) to the configuration file 318. In block 540, the user survey loop may terminate.

In block 542, a security module 418 (FIG. 4) of OOBE program 316 starts a user security loop. In block 544, security module 418 performs a decision operation in which the device user is asked whether they wish to configure fingerprint or facial recognition security for computer 114. If the device user response negatively to block 544, then in block 550, the user security loop may terminate. However, if the device user responds positively to block 544, then in block 546, security module 418 assists the device user to setup appropriate security settings for computer 114. In block 548, security module 418 may then configure the operating system and the BIOS of computer 114 with the specified security settings. In block 542, the user security loop may terminate. In block 552, OOBE program 316 utilizes collected configuration data from configuration file 318 to configure the operating system user interface (UI) with a setup that optimally suits the needs of the device user of computer 114. The FIG. 5 procedure may then terminate.

Referring now to FIG. 6, a diagram illustrating a configuration file creation procedure is shown, in accordance with one embodiment of the present invention. The FIG. 6 example is presented for purposes of illustration, and in alternate embodiments, the present invention may utilize steps and sequences other than certain of those steps and sequences discussed in conjunction with the FIG. 6 embodiment.

In the FIG. 6 embodiment, in block 614, a device user initially boots computer 114 and the OOBE program 316 (FIG. 3) starts automatically as shown in block 616. A configuration file 318 (FIG. 3) is also started, and a usage tracker 416 (FIG. 4) is started, as shown in block 632. In blocks 618, 620, and 622, a user information loop is executed to collect and store appropriate user information input into a configuration file 318 (FIG. 3). Similarly, in blocks 624, 626, and 622, a user survey loop is executed to collect and store appropriate user survey input into the configuration file 318 (FIG. 3). In addition, in blocks 628, 630, and 622, a user security loop is executed to collect and store appropriate user security input into the configuration file 318 (FIG. 3).

In block 634, the user tracker 416 of OOBE program 316 monitors activities of the device user and any other appropriate entities to identify predefined types of tracking data, as illustrated by the examples shown in block 634. In block 636, OOBE program 316 compiles the tracking data, and performs a user analysis procedure to determine whether the device user should be categorized as an advanced user or typical/standard user. The tracking data and the results of the user analysis procedure may be stored in the configuration file.

In block 638, OOBE program 316 reads the collected configuration data from configuration file 318 to configure the operating system user interface (UI) with a setup that optimally suits the needs of the device user of computer 114. The FIG. 6 procedure may then terminate.

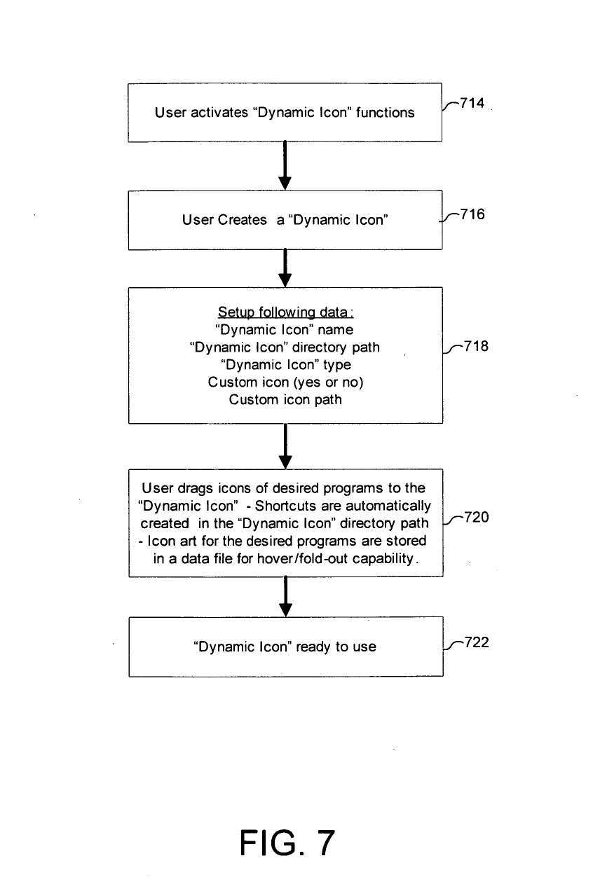

Referring now to FIG. 7, a diagram illustrating a dynamic icon creation procedure is shown, in accordance with one embodiment of the present invention. The FIG. 7 example is presented for purposes of illustration, and in alternate embodiments, the present invention may utilize steps and sequences other than certain of those steps and sequences discussed in conjunction with the FIG. 7 embodiment.

In the FIG. 7 embodiment, in block 714, a device user may initially activate dynamic icon functionality for computer 114. In block 716, the device user may utilize an icon manager 322 (FIG. 3) to create a dynamic icon. In block 718, the device user may utilize icon manager 322 to setup icon data relating to the particular dynamic icon. Examples of such icon data are shown in block 718 of FIG. 7. In block 720, the device user may drag icons of desired nested programs to the dynamic icon. In response, shortcuts for the nested programs are automatically created in the directory path of the dynamic icon. In certain embodiments, icon art for the nested programs is stored in an icon art data file to support hover/fold-out capabilities for viewing and utilizing the nested programs. Finally, in block 722, the dynamic icon is ready for use. The FIG. 7 procedure may then terminate.

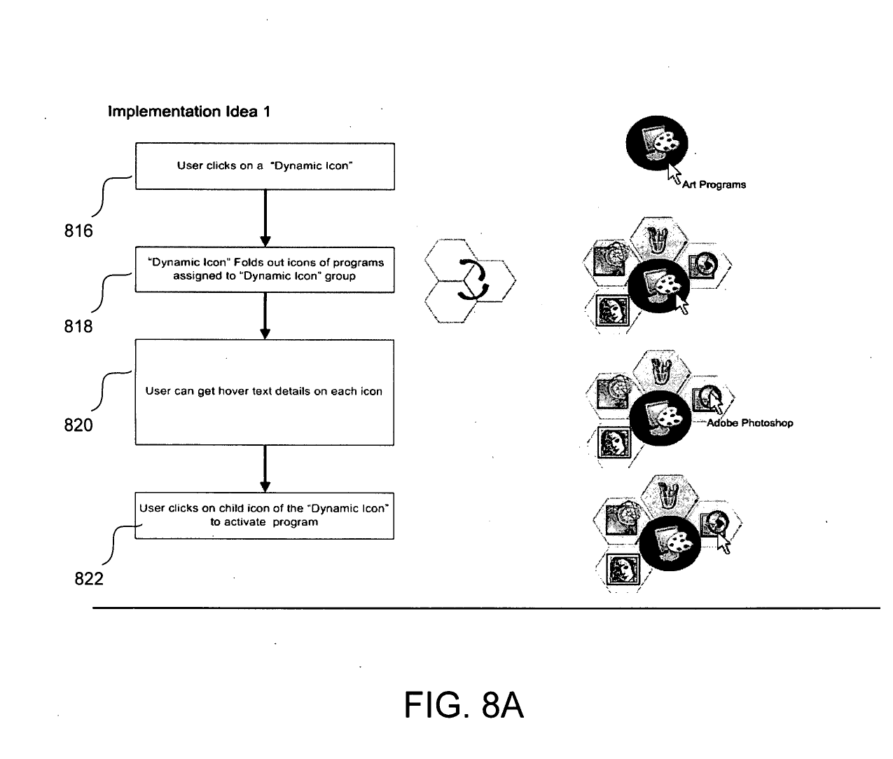

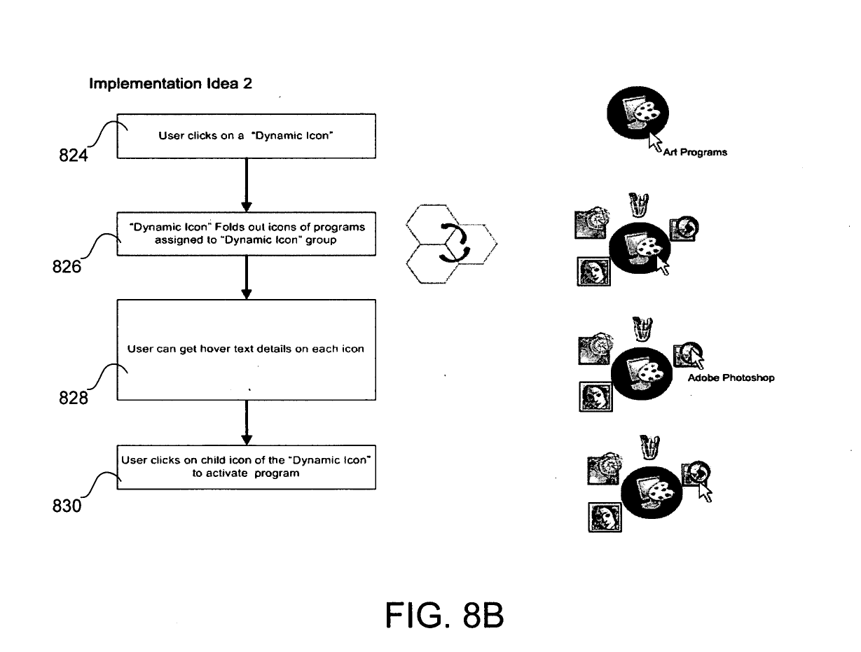

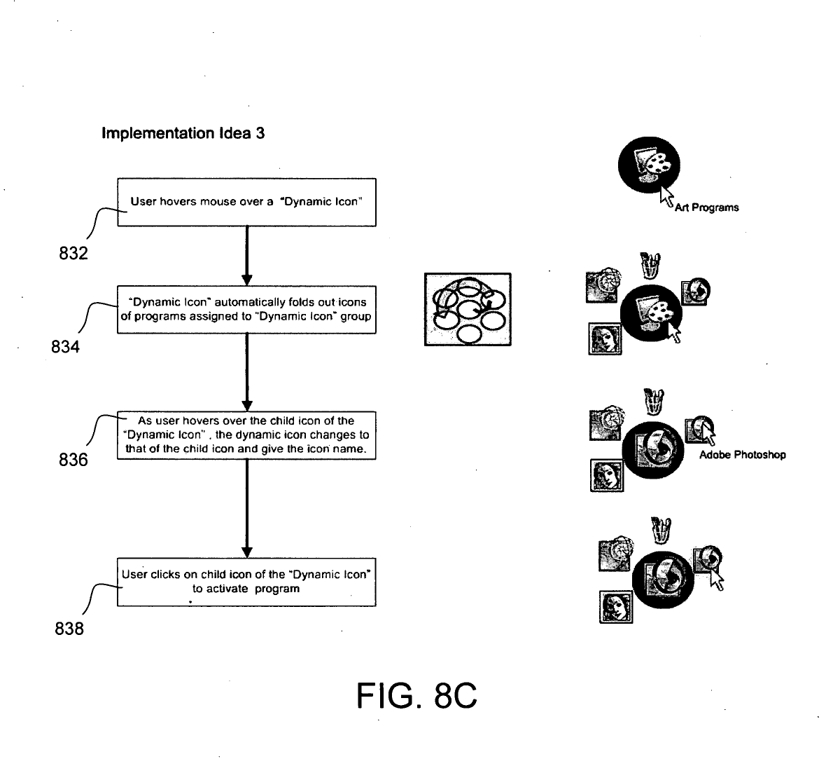

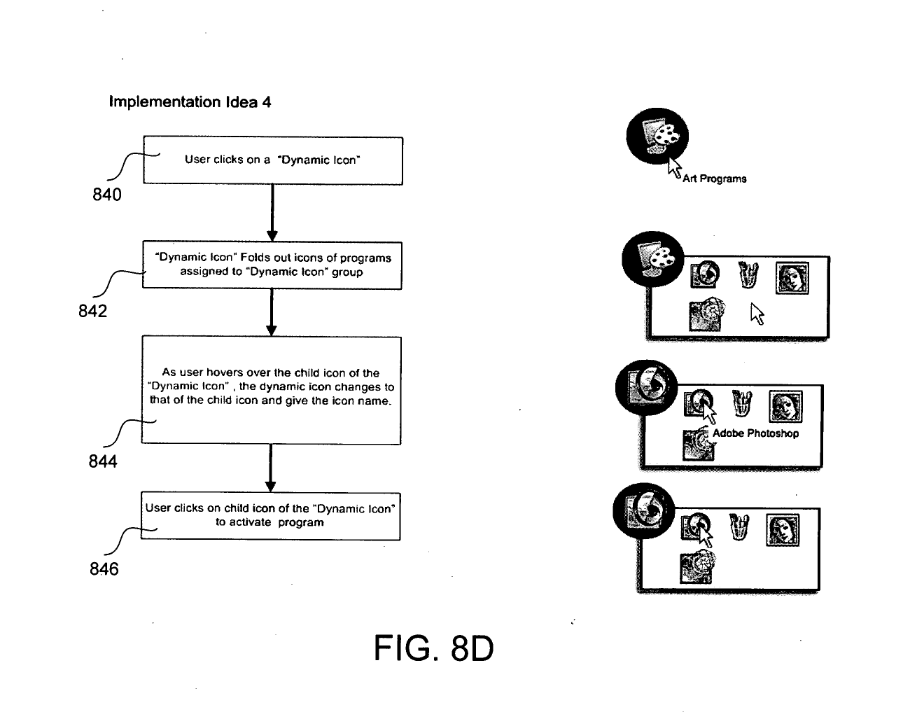

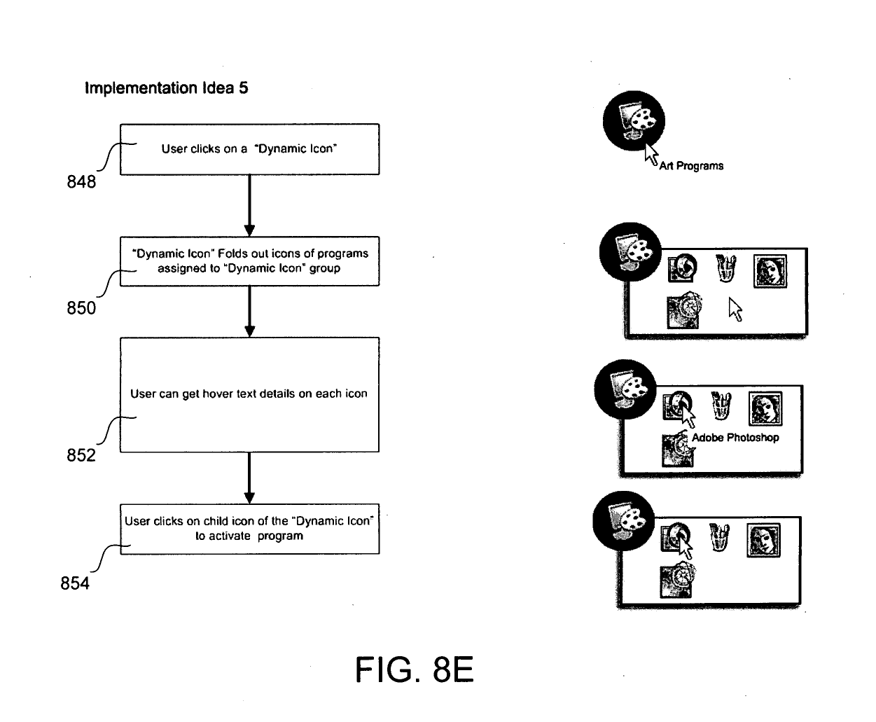

Referring now to FIGS. 8A-8E, diagrams illustrating dynamic icon utilization procedures are shown, in accordance with respective embodiments of the present invention. The examples of FIGS. 8A-8E are presented for purposes of illustration, and in alternate embodiments, the present invention may utilize steps and techniques other than certain of those steps and techniques discussed in conjunction with the embodiments of FIGS. 8A-8E. In FIGS. 8A-8E, the numbered process steps describe various implementation ideas for utilizing dynamic icons. For each of the number process steps in FIGS. 8A-8E, a corresponding graphical representation is provided horizontally to the right of the respective process step.

In the FIG. 8A embodiment, in step 816, a device user initially selects (clicks on) a dynamic icon (for art programs). In step 818, the dynamic icon folds out icons of child programs assigned to the dynamic icon group. In step 820, the device user may obtain hover text details for each child icon by placing the cursor over a given child icon (here, Adobe Photoshop). In step 822, the device user clicks on a child icon from the dynamic icon group to activate the selected child program.

In the FIG. 8B embodiment, in step 824, a device user initially selects (clicks on) a dynamic icon (for art programs). In step 826, the dynamic icon folds out icons of child programs assigned to the dynamic icon group. In certain embodiments, the icons of the child programs may be animated to rotate around the central dynamic icon. In step 828, the device user may obtain hover text details for each child icon by placing the cursor over a given child icon (here, Adobe Photoshop). In step 830, the device user clicks on a child icon from the dynamic icon group to activate the selected child program.

In the FIG. 8C embodiment, in step 832, a device user initially selects a dynamic icon (for art programs) by hovering the cursor over the dynamic icon. In step 834, the dynamic icon automatically folds out icons of child programs assigned to the dynamic icon group. In step 836, as the device user hovers the cursor over the child icon, the dynamic icon changes to that of the child icon and displays the child icon name (here, Adobe Photoshop). In step 838, the device user clicks on a child icon of the dynamic icon group to activate the selected child program.

In the FIG. 8D embodiment, in step 840, a device user initially selects (clicks on) a dynamic icon (for art programs). In step 842, the dynamic icon folds out icons of child programs assigned to the dynamic icon group. In step 844, as the device user hovers the cursor over the child icon, the dynamic icon changes to that of the child icon and displays the child icon name (here, Adobe Photoshop). In step 846, the device user clicks on a child icon of the dynamic icon group to activate the selected child program.

In the FIG. 8E embodiment, in step 848, a device user initially selects (clicks on) a dynamic icon (for art programs). In step 850, the dynamic icon folds out icons of child programs assigned to the dynamic icon group. In step 852, the device user may obtain hover text details for each child icon by placing the cursor over a given child icon (here, Adobe Photoshop). In step 854, the device user clicks on a child icon from the dynamic icon group to activate the selected child program.

The present invention has been explained above with reference to certain embodiments. Other embodiments will be apparent to those skilled in the art in light of this disclosure. For example, the present invention may readily be implemented using configurations and techniques other than those described in the embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. An electronic device comprising:
a user interface that a device user utilizes to interact with said electronic device;
means for enhancing one or more utilization capabilities of said user interface; and
a processor device that is configured to control said means for enhancing.

2. The electronic device of claim 1 wherein said user interface includes a desktop area presented on a display of a computer device.

3. The electronic device of claim 1 wherein said means for enhancing includes a configuration program that coordinates an out-of-the-box procedure to initially configure said electronic device.

4. The electronic device of claim 3 wherein said configuration program gathers configuration data for performing said out-of-the-box procedure, said configuration data being stored in a configuration file.

5. The electronic device of claim 4 wherein said configuration program executes a user information loop to collect predefined user information for storage in said configuration file.

6. The electronic device of claim 4 wherein said configuration program executes a user survey loop during which a survey module requests survey answers from said device user to predefined survey questions, said survey answers being stored into said configuration file.

7. The electronic device of claim 4 wherein said configuration program executes a user security loop during which a security module interacts with said device user to setup security features for said electronic device.

8. The electronic device of claim 4 wherein said configuration program includes a usage tracker that monitors usage characteristics of said device user to identify a technological level of said device user, said technological level including whether said device user is an advanced user or a standard user, said configuration program storing said technological level into said configuration file.

9. The electronic device of claim 4 wherein said configuration program includes a query module that automatically searches for user information on an electronic network of distributed computers, said user information including whether said device user is a participant at any social networking websites.

10. The electronic device of claim 3 wherein said means for enhancing includes a search module that supports a drag-and-drop search function during which said device user drags local metadata into a search window, said search module automatically locating matching metadata on a distributed computer network.

11. The electronic device of claim 3 wherein said means for enhancing includes an icon manager that supports dynamic icons on said user interface, said dynamic icons hosting nested child icons that represent shortcuts to selected computer programs.

12. The electronic device of claim 1 wherein a first aspect of said means for enhancing supports pre-configuring said user interface based upon either advanced or standard personalities of said device user, said means for enhancing further supporting a set of profiles that are implemented by utilizing user feedback.

13. The electronic device of claim 1 wherein a second aspect of said means for enhancing supports utilizing information gathered during an out-of-the-box procedure to configure said electronic device, said information being utilized to set up one or more social networking software portals, said information being further utilized to setup fingerprint or facial recognition features for system security on said electronic device.

14. The electronic device of claim 1 wherein a third aspect of said means for enhancing supports a query module that utilizes one or more e-mail addresses of said device user to perform a search procedure for determining online services and websites with which said device user communicates, said means for enhancing the automatically performing device configuration functions using search results from said search procedure.

15. The electronic device of claim 1 wherein a fourth aspect of said means for enhancing automatically performs a user analysis procedure with predefined evaluation criteria to identify whether said devices user is an advanced user or a standard user.

16. The electronic device of claim 1 wherein a fifth aspect of said means for enhancing supports an expanded search manager that provides a drag-and-drop search bar and local metadata on said user interface, said device user dragging and dropping desired a search item into said drag-and-drop search bar, said expanded search manager then automatically performing a query procedure against all of said local metadata associated with said search item.

17. The electronic device of claim 1 wherein a sixth aspect of said means for enhancing includes an icon manager that supports dynamic icons on said user interface, said icon manager creating said dynamic icons on the desktop to act as containers for selected child software programs.

18. The electronic device of claim 17 wherein said icon manager supports dynamic icons for any desired dynamic icon categories that include a productivity software category, a computer-specific software category, and an entertainment software category.

19. The electronic device of claim 17 wherein said device user positions a mouse cursor over a given dynamic icon, said icon manager automatically expanding said given dynamic icon to show useful software programs that are nested within said given dynamic icon.

20. A method for implementing an electronic device comprising:
utilizing a user interface to interact with said electronic device;
providing means for enhancing one or more utilization capabilities of said user interface; and
controlling said means for enhancing by utilizing a processor device.
